(19) United States
(12) Patent Application Publication
(10) Pub. No.: US 2009/0041624 A1
(43) Pub. Date: Feb. 12, 2009

(54) FLUIDIC STRUCTURE AND METHOD FOR PRODUCTION OF A FLUID STRUCTURE

(76) Inventors: Gernot Hochmuth, Mannheim (DE); Gregor Ocvirk, Mannheim (DE); Wolfgang Fiedler, Laudenbach (DE)

Correspondence Address: BARNES & THORNBURG LLP (Roche), 11 SOUTH MERIDAN STREET, INDIANAPOLIS, IN, 46204, US

(21) Appl. No.: 11/722,973

(22) PCT Filed: Dec. 22, 2005
(86) PCT No.: PCT/EP05/13910

§ 371 Date: Feb. 27, 2008

(30) Foreign Application Priority Data
Jan. 5, 2005 (DE) 10 2005 000 799.6

(51) Int. Cl. B01J 19/00; B32B 37/00; B32B 38/10; B32B 38/06; C23F 1/00; B32B 38/00

(52) U.S. Cl. 422/68.1; 156/293; 156/273.3; 156/154; 156/221; 156/272.8; 216/36; 156/73.1; 156/272.2

(57) ABSTRACT

A fluidic structure and a method for production of a fluidic structure are provided. The method may comprise, in order, introducing at least one externally accessible opening into at least one base substrate of the fluidic structure, partially introducing at least one section of a fluidic conductor, which has at least one inner lumen and at least one conductor wall, in particular of a tube or flexible tube, into the at least one opening, introducing at least one curable fluid sealing material into the at least one opening, entirely or partially curing the at least one fluid sealing material, and producing at least one connecting channel between at least one inner lumen in the at least one fluidic conductor and at least one fluid channel in the fluidic structure, the at least one connecting channel passing through at least one conductor wall.

### CROSS-REFERENCE TO RELATED APPLICATION

This application is a U.S. National counterpart application of International Application No. PCT/EP2005/013910, filed Dec. 22, 2005, which claims priority to German Patent Application No. 102005000799.6, Jan. 5, 2005, the disclosures of which is incorporated herein by reference.

### FIELD OF THE INVENTION

The invention relates to a method for coupling a fluidic conductor to a fluidic system, and to an arrangement which has a fluidic system as well as a fluidic conductor which is coupled to this system using the described method. Arrangements and fluidic systems such as these are used in particular for chemical analysis, for medical diagnosis and for other biological and medical applications. Arrangements and systems such as these can also be used in chemical synthesis and reactor systems. In particular, arrangements and systems such as these can be used in the form of microfluidic systems.

### BACKGROUND

Various methods are known in which fluidic conductors, in particular flexible tube systems, can be coupled to fluidic systems, for example microfluidic chips. The purpose of systems such as these may in this case be widely different, and may include applications mentioned above for analysis and diagnosis in biological and medical applications, for example for the purpose of microdialysis and chemical reactor systems.

WO 03/072251 A2 describes a microfluid system having at least one volume through which flow can pass and having at least one connecting device which is connected to the volume and is in the form of a tapering depression or a tapering projection. Furthermore, WO 03/072251 A2 describes a connector device for use in a microfluid system such as this, which is designed such that it can be engaged with the described connecting device. In the microfluid system which is described in WO 03/072251 A2, the production of such microfluid systems, in particular, is complex, since the production of the tapering depressions and/or of the tapering projections in the connecting device are/is technically difficult to implement, and the corresponding connector device also requires a complex production method. Furthermore, the microfluid system that is described in WO 03/072251 A2 has an undefined dead volume since corresponding cavities can be formed when the described connecting device and the connector device are plugged together, and these must first of all be filled with fluid. Furthermore, the described arrangement can be used only for flexible tubes or tubes with a relatively high mechanical load capacity.

US 2004/0017078 A1 discloses a connection between a microfluidic system and a flexible tube, in which a connecting stub is formed in the microfluidic system, to which a flexible tube can be connected. In this case, the connecting stub does not project beyond the substrate surface of the microfluidic system, but is recessed in a hole in the substrate. Furthermore, in the system which is described in US 2004/0017078 A1, in a similar way to the system which is described in WO 03/072251 A2, the connection can be used only for flexible tubes with a relatively high mechanical load capacity.

Various methods by means of which fluidic connections can be implemented in silicon-based integrated microfluidic systems are described in Gray et al.: “Novel interconnection technologies for integrated microfluidic systems”, Sensors and Actuators 77 (1999), 57-65. In particular, in this case, connecting depressions which are produced by reactive ion etching are once again proposed, which are connected to fluidic channels that are integrated in the silicon chip, and into which correspondingly fluidic small tubes can be inserted. These openings or depressions may also once again be provided with connecting stubs incorporated in them, in a similar way to the method described in US 2004/0017078 A1. However, method is restricted to substrates which can be etched, in particular silicon, and necessitates complex hardware techniques, such as reactive ion etching.

DE 202 16 216 U1 discloses a microfluid system, in particular a microflow sensor, which has an input/output opening in a wafer, and a connecting element for the input/output opening. The connecting element covers the surface of the wafer in the area of the input/output opening and has a casing with a projection. An adhesive connection is produced between the projection from the casing and the wafer. In the system described in DE 202 16 216 U1, large dead volumes occur in particular during the production of the connection between the connecting element and the wafer, and can be calculated only with difficulty. Furthermore, the described connection method leads to microfluidic systems with a comparatively low packing density of the connecting elements, in particular because of the fact that the connecting elements are sealed from the outside by means of the adhesive connection. However, a high packing density is an essential precondition for many applications in the field of microfluidics.

Standard connecting elements are described in Meng et al.: “Micromachined Fluid Couplers”, in “Proceedings Of The Micro Total Analysis Systems 2000 Symposium”, held in Enschede, the Netherlands, 14-18 May 2000, Publisher: Berg et al., MESA Monographs, Kluwer Academic Publishers, the Netherlands, pages 41-44, by means of which corresponding tubes can be connected to a microfluidic system which is embedded in a silicon wafer. In this case, silicon wafers are structured in such a manner that they hold a tube on one face and can be connected to the input/output opening of a wafer on the other face. The described connecting elements are in this case manufactured directly from silicon (bulk couplers or post couplers) or from a silicon mould moulded in a polymer (moulded couplers). Polymer couplers can be attached to the wafer or substrate by adhesive bonding, in particular by fusion adhesive bonding. However, the production method for the couplers is extremely complex and includes a number of semiconductor production steps. Furthermore, complex hardware facilities are required, such as devices for reactive ion etching. Furthermore, one of the refinements of the described method can be used only for tubes with a relatively high mechanical load capacity.

A connecting concept for tubes to a silicon microfluidic chip is described in Yao et al.: “Micromachined Rubber O-ring Microfluidic Couplers”, 13th IEEE International Conference on Micro Electro Mechanical Systems (MEMS 2000), Miyazaki, Japan, 23-27 Jan. 2000, in which integrated rubber and silicone O-rings are produced. However, once again the described method is highly complex, in particular because the production of the integrated sealing rings requires complex hardware. Furthermore, the described method (as in some cases the methods described above as well) is restricted to substrate materials which allow appropriate etching techniques and other semiconductor processes, that is to say in particular silicon.

Microfluidic connections are described in Puntambekar et al.: “Self-aligning microfluidic interconnects for glass- and plastic-based microfluidic systems”, in Journal of Micromechanics and Microengineering, 12 (2002), 35-40 and Puntambekar et al.: “Self-aligning microfluidic interconnects with low dead volume”, in “Proceedings Of The Micro Total Analysis Systems 2000 Symposium”, held in Enschede, the Netherlands, 14-18 May 2000, Publisher: Berg et al., MESA Monographs, Kluwer Academic Publishers, the Netherlands, pages 323-326, which are suitable for serial and parallel connection techniques with a small dead volume and a small pressure drop (approximately 1000 Pa). In this case, the end of a flexible tube that is to be connected is surrounded by an additional flange flexible tube. The substrate which is held has a flange cavity in the interior, which a portion of the flange flexible tube can enter during the insertion of the described double flexible tube end, in order in this way to form a firm connection to the substrate. Once again, however, the described method is comparatively complex since, in particular, high temperatures (above 300° C.) and high pressure are required to produce the connecting piece. The described method is not suitable for polymer substrates, in particular because of these production conditions. Furthermore, the described connection can be used only for tubes with a comparatively high mechanical load capacity, because the flexible tube to be connected must be pressed into the substrate with a large amount of force being applied.

U.S. Pat. No. 6,290,791 B1 and EP 0 944 794 B1 disclose an arrangement having a micromechanically produced structure as well as a capillary or tube, and a method for connection of the capillaries or tubes to the structure. The micromechanically produced structure in this case has a substrate into which fluidic flow channels are introduced, and are connected to an opening into which the tube can be inserted. A sealing substance is then introduced into the opening around the tube and is cured, in order to seal the tube within the opening. One particular problem in this case is how to prevent the sealing substance from entering the flexible tube and/or the tube, and closing them. Various alternatives have been proposed in order to solve this problem. In particular, it has been proposed that a light-curing adhesive be used as the sealing substance, with the inserted end of the flexible tube or of the tube being illuminated using a suitable light source, so that the light-curing adhesive is cured before reaching the end of the flexible tube or of the tube, and is thus stopped, and, in particular when the inserted length of a flexible tube, that is to say the length by which a flexible tube is inserted into the opening, is only very short (in particular less than 1 mm), it is very difficult to stop a light-curing adhesive since, in particular, the light sources that are used themselves have a certain physical extent and fuzziness at the edges, and are virtually impossible to position with the required precision. Furthermore, as an alternative, it has also been proposed that a thread be inserted into the flexible tube or the tube, which cannot be connected to the sealing substance, so that the fluidic connection between the capillary opening and the connecting channel is kept free by the thread. It must be possible to remove the thread subsequently.

However, the method described in U.S. Pat. No. 6,290,791 B1 and EP 0 944 794 B1 is associated with numerous uncertainties because of the problems already mentioned, and these reduce the suitability of the described method for large-scale use. The insertion of a thread into a tube or into a flexible tube is virtually impossible for large-scale use since, in particular, handling or extremely complex technical equipment is required for this purpose. A thin-walled flexible tube which can be deformed easily can also easily be damaged when threading in a thread. The alternative that has also been proposed of monitoring the ingress of the sealing substance, in particular of the light-curing adhesive, by the influence of a light source, is associated with numerous uncertainties. In particular, any fluctuation in the light intensity of the light source used can lead to the light-curing adhesive entering the opening to different extents and thus, in many large-scale manufacturing situations, can close or constrict the end of the tube or of the flexible tube, or even enter the fluidic channels of the micromechanically produced structure. Furthermore, the proposed method is dependent on the ability to insert the flexible tube or the tube into one of the described openings. This is not possible without problems, particularly in the case of thin-walled flexible tubes which can be deformed easily, since they can be damaged in the process. Furthermore, the production of the proposed openings, in particular, requires complex micromechanical drilling or milling, since the conductor channel in the flexible tube must be positioned exactly with respect to the corresponding conductor channel in the microfluidic structure, which once again necessitates complex positioning relative to the fluidic flow channels introduced into the substrate.

U.S. Pat. No. 6,605,472 B1 describes a method by means of which a small capillary tube can be connected to a microchip, with the microchip having a capillary channel opening on one edge surface. In this case, a hole which is aligned with the capillary opening is drilled into the edge of the microchip, into which hole the end of the small capillary tube can be inserted, so that the small capillary tube is connected to the capillary channel in the microchip. However, the described method is once again technically extremely complex since—in a similar manner to that in U.S. Pat. No. 6,290,791 B1 and EP 0 944 794 B1—precision drilling and precision positioning are required. The hole must be arranged axially with respect to the capillary channel in order to allow fluid to flow from the small capillary tube directly into the capillary channel in the microchip. Furthermore, in particular in order to avoid dead volumes, it is necessary to flatten the base of the hole afterwards, before the insertion of the small capillary tube. In addition, a hot adhesive is used to fix the small capillary tube in the hole. High temperatures of up to 800° C. must be applied in order to fix the connection, which precludes the use of this method, in particular, for polymer structures.

### SUMMARY

A method is provided for coupling a fluidic conductor to a fluidic system. The described method and an arrangement produced using this method should be cost-effective, in particular should also be suitable for microfluidic systems, and should provide a high degree of flexibility for the choice of materials.

A method is proposed for production of a fluidic structure, for example a microfluidic structure, which can be used for one of the purposes mentioned above. The fluidic structure may in this case be used in particular for processing and/or handling of fluid media, for example of liquids or gases. Primary applications in this case are, in particular, in the field of medical diagnosis, analysis or chemical reactor systems, in particular microreactor systems. The method is intended to include the following steps:

First of all, at least one externally accessible opening is introduced into a base substrate of the fluidic structure. The at least one base substrate may, for example, be in the form of inorganic substrates, for example silicon substrates or glass, or else organic substrates, in particular various polymers, such as silicone, polycarbonate or Cyclic Olefin Copolymers (COC). Base substrates composed of different materials are also feasible.

By way of example, the at least one opening may be a hole that is introduced into the at least one base substrate, in particular a blind hole with, for example, a round, oval or polygonal cross section. Additionally or alternatively, the at least one opening may also be a groove which is arranged on one surface of the at least one base substrate and is externally accessible. For example, this groove may be accessible along its long face from one surface of the at least one base substrate, with the groove being accessible from an end face of the at least one base substrate. The groove may, for example, have a rectangular, round, U-shaped or V-shaped cross section. Furthermore, the groove may also have a cross section in the form of a trapezoid, in which case the longer of the two parallel edges of the trapezoid illustratively rests on one surface of the at least one base substrate. This refinement makes it easier to insert a fluidic conductor.

In a second method step, at least one section of a fluidic conductor, which has at least one inner lumen and at least one conductor wall, in particular of a tube or flexible tube, is partially introduced into the at least one opening. This fluidic conductor may, for example, be a flexible or rigid tube or a corresponding flexible tube composed of inorganic or organic material, for example metals, silicone, Teflon, glass or PVC. In this case, the expression an inner lumen means a fluidic cavity in the interior of the fluidic conductor, through which a fluid medium can flow. In particular, the at least one section of the at least one fluidic conductor may be the end of a tube or flexible tube, in particular an open end which is introduced into the at least one opening. This introduction process is illustratively carried out in such a way that a cavity remains between the outer wall of the at least one fluidic conductor and the wall of the at least one opening. In particular, in this case, the at least one section of the at least one fluidic conductor can be introduced into the at least one opening in such a way that a flexible tube or tube, or one end of such a flexible tube or tube, is inserted into one of the grooves described above, or is pushed into one of the holes described above.

In a subsequent method step, at least one curable fluid sealing material is introduced into the at least one opening. This introduction of the fluid sealing material may be carried out, for example, directly into the externally accessible opening, for example by means of a pipette or micrometering system. In this case, by way of example, a metering needle or a similar apparatus may be used by means of which, for example, fluid sealing material is introduced directly into one of the grooves described above or into one of the holes. Alternatively or additionally, the curable fluid sealing material can also be introduced into the at least one opening by providing at least one filling channel, which is connected to the at least one opening, in the fluidic structure. This filling channel may, for example, be externally accessible. This filling channel may be in the form of a single channel or else may have branches, and may be connected to one of the openings or else to a plurality of openings at the same time. Fluid sealing material can flow through this filling channel into the at least one opening. It is desirable for the fluid sealing material to entirely or completely fill one or more intermediate spaces which remain between the at least one fluidic conductor and the at least one opening after the at least one section of this at least one fluidic conductor has been introduced into the at least one opening. This filling channel may, for example, be introduced into the at least one base substrate. Furthermore, this at least one filling channel may also pass through further substrates, for example at least one intermediate substrate and/or cover substrate. If the at least one section of the introduced at least one fluidic conductor has at least one open end, for example a flexible tube or tube end, which has been introduced into the at least one opening, then it has been found to be desirable for the at least one curable fluid sealing material to close this at least one open end after being introduced into the opening. By way of example, the at least one curable fluid sealing material may partially enter this tube or flexible tube end, and may thus close this open end. In this case, the expression closure means in particular and for example a sealed closure with regard to the fluidic media which flow through the at least one inner lumen in the at least one fluidic conductor. Furthermore, it is desirable or the curable fluid sealing material to close the intermediate space, as described above, between the at least one fluidic conductor and the surrounding wall of the at least one opening such that it forms a seal for the fluidic media in the inner lumen in the at least one fluidic conductor. This curable fluid sealing material should be in the liquid state after being introduced. In a subsequent method step, once the curable fluid sealing material has been introduced into the at least one opening, the at least one fluid sealing material is entirely or partially cured. In this case, the expression curing means a transition (for example a liquid/solid phase transition or else a transition resulting from a chemical reaction), in which the hardness and/or viscosity of the curable fluid sealing material are/is greatly increased. In this case, the curable fluid sealing material need not be completely solid but may also, for example, still be in a slightly plastic or elastic state. However, it is desirable in this case for a firm connection to be produced between the at least one base substrate of the fluidic structure and the at least one fluidic conductor. In this way, the connection between the at least one fluidic conductor and the at least one base substrate is thus made mechanically robust, and is thus protected against undesired removal of the fluidic conductor. This is the case in particular when the at least one section of the at least one fluidic conductor which is introduced into the at least one opening in the at least one base substrate has a length of at least 0.2 mm, illustratively of more than 0.5 mm and further illustratively in the range between 0.5 and 1.5 mm. The optimum length of this at least one section is, however, also dependent on the external dimensions of the at least one fluidic conductor, for example its diameter.

Various materials may be used for the at least one curable fluid sealing material. In this case, in particular, it may be a curable fluid sealing material which is initially in the liquid state and can then be cured by the influence of electromagnetic rays. By way of example, it may thus be a liquid of a photopolymerizable monomer. The curing can then be carried out, for example, by means of a large-area light source, illustratively a UV light source, or else by means of a light source with a limited area. In particular, the curing can also be carried out just locally (for example by means of an exposure mask) or else at different points in the fluidic structure at different times. In particular, a laser can also be used for the curing process, in particular a laser whose wavelength is optimally matched to the curable fluid sealing material. In particular, the electromagnetic rays which are used for the curing process may also entirely or partially pass through the fluidic structure, for example the at least one base substrate or else further substrates, for example intermediate substrates or cover substrates, before acting on the at least one curable fluid sealing material. For this purpose, it is desirable for the at least one substrate through which the electromagnetic rays pass to have a low level of absorption for the electromagnetic rays that are used. In particular, substrates which are transparent to light may thus, for example, be used.

Alternatively or additionally, it is also possible to use curable fluid sealing materials whose curing is carried out by means of thermal action. This thermal action may, for example, be a temperature increase, for example when monomer fluids are used which carry out a polymerization process (thermally initiated polymerization) when the temperature is briefly increased, and are cured during this process. However, alternatively or additionally, it is also possible to use a temperature decrease. This is desirable when using fluid sealing materials which are liquid at a raised temperature and become solid when the temperature is subsequently reduced, for example to room temperature (a liquid/solid phase transition).

Alternatively or additionally, increased pressure can also be used for the introduction of the at least one curable fluid sealing material. In this case, materials which can flow at this increased pressure are illustratively used as curable fluid sealing materials, in order to enter the at least one opening. By way of example, this may be at least one viscoelastic or pseudoplastic sealing material. Materials such as these can flow in a corresponding manner under the influence of an increased pressure, with complete or partial curing subsequently taking place when the pressure is reduced.

However, the choice of the curable fluid sealing materials is not restricted to the materials that are being mentioned. For example, it is also possible to use curable fluid sealing materials which cure with time by themselves (that is to say without any active external influence), for example by means of an appropriate polymerization reaction. In particular, for example, it is also possible to use monomer liquids with appropriate initiators, which have flowing characteristics for a certain time and then cure. These materials must then be introduced into the at least one opening during the time during which these materials can flow. In particular, these materials may, for example, be epoxies or silicones. Inorganic materials can also be used, such as self-curing cements.

After the curing of the at least one fluid sealing material, at least one connecting channel is then produced between at least one inner lumen in the at least one fluidic conductor, in particular in the at least one section which is introduced into the at least one opening, and at least one fluid channel in the fluidic structure. This at least one connecting channel produces a connection, through which the fluidic media can flow, between the at least one fluidic conductor and the remaining area of the fluidic structure.

For this purpose, it is, of course, necessary for the remaining fluidic structure to have one or more fluid channels such as these. A fluid channel such as this may, for example, be introduced into the at least one base substrate of the fluidic structure. Furthermore, however, this at least one fluid channel may also be introduced in additional substrates, for example in one or more cover substrates. In this case, by way of example, the expression a fluid channel can mean a hole in one of the substrates, or else a corresponding groove on a surface of one of the substrates. Corresponding relatively large cavities, such as microreaction chambers, or else further fluidic conductors which have been introduced into the fluidic structure, are also covered by the expression fluid channel.

The at least one connecting channel may pass through a subarea of one of the said substrates, or else a plurality of subareas, or entire substrates at the same time. In particular, the connecting channel may also pass through corresponding intermediate substrates. The at least one connecting channel may in this case be a single channel or else have branches. Furthermore, this at least one connecting channel may also illustratively pass through at least one of the abovementioned sealing materials (which are then illustratively in the cured state), as well as, by way of example, at least one conductor wall of at least one fluidic conductor as well.

Various methods of a physical, mechanical or chemical nature may be used to produce this at least one connecting channel, and are optimally matched to the materials used for the substrate or substrates, the sealing material or materials and/or the conductor wall or walls of the fluidic conductors. In particular, it is possible to use a mechanical drilling method or milling method, or else a stamping method additionally or alternatively. An appropriate laser beam method, for example laser beam drilling or laser ablation, can also be used. In particular, it is possible to use CO₂ lasers, or other gas lasers, or else Nd:YAG lasers or other solid-state lasers operated continuously or in a pulsed mode for this purpose. Mechanical methods or laser beam methods such as these are optimally accompanied by appropriate suction measures, in order to absorb dust particles which are produced which occur during the production of the at least one connecting channel. Additionally or alternatively, it is also possible to use chemical methods, in particular wet-chemical methods, for example etching methods or methods in which solvents are used, or else dry etching methods, for example by the use of reactive ion etching.

As has already been described above, the method can be modified in such a way that at least one further substrate is used in addition to the at least one base substrate with the at least one externally accessible opening. In particular, this allows a corresponding layer configuration to be produced for the fluidic structure, and, in particular, this greatly simplifies the production of fluid channels, reaction chambers or similar cavities in the interior of the fluidic structure. In particular, in this case, it is possible to apply at least one intermediate substrate and/or one cover substrate to the at least one base substrate. Illustratively the at least one cover substrate and/or the at least one intermediate substrate partially closes the at least one opening. By way of example, these may be one or more unstructured intermediate substrates and at least one structured cover substrate, for example with the at least one cover substrate having at least one fluid channel. Further fluidic cavities, for example reaction chambers or else further fluidic conductors, can also be introduced into the cover substrate. By way of example, the at least one opening in the at least one base substrate may be in the form of a groove (see above), which is accessible from its longer face on a surface of the at least one base substrate, and on its end surface from one end face of the at least one base substrate. Once the at least one section of the at least one fluidic conductor has been introduced into this at least one opening, and once the at least one fluid sealing material has been introduced into the opening, the opening, in particular a groove, can then be closed by application of an intermediate substrate, in particular an unstructured intermediate substrate. Further structures on the base substrate, for example fluid channels which are introduced into the at least one base substrate in the form of further grooves along this surface, can also be closed by the at least one intermediate substrate during this process, so that closed fluid channels are formed. By way of example, one or more structured cover substrates can then be applied to this layer configuration, comprising the at least one base substrate and the at least one intermediate substrate. In particular, these cover substrates may once again have fluid channels, for example once again corresponding grooves on one surface of the at least one cover substrate, which are illustratively once again entirely or partially closed on application to the other substrates. Once again, this results in closed fluidic conductors. Alternatively, it is also possible to apply at least one correspondingly structured cover substrate directly to the at least one base substrate, without using a corresponding unstructured intermediate substrate.

In particular, the layer configuration can in this case be designed such that at least one fluid channel is located above or in the vicinity of the at least one opening in the finished, structured fluidic structure. This makes it considerably easier to connect this at least one fluid channel to the at least one inner lumen in the at least one fluidic conductor by means of at least one connecting channel.

By way of example, the method can be carried out in such a way that one section of a fluidic conductor is introduced into an opening, fluid sealing material is then introduced and is cured, and an intermediate substrate is then applied to the base substrate. A hole is then produced through the intermediate substrate, the cured sealing material and the conductor wall of the fluidic conductor to the inner lumen in the fluidic conductor, for example by means of a laser. A cover substrate, for example a cover substrate with structured fluid channels on one of its surfaces, for example appropriate grooves, can then be applied to this structure, with one or more fluid channels of this cover substrate illustratively being located above the said hole. This allows a three-dimensional fluidic structure to be produced by means of a layer configuration, with closed fluid channels and a connection through which a fluid can flow between the inner lumen in the fluidic conductor and a fluid channel in the fluidic structure. Alternatively, it is also possible to dispense with the unstructured intermediate substrate, with the said hole being produced, for example, only through the cured sealing material and the conductor wall of the fluidic conductor. In particular, the method can also be carried out in such a way that, first of all, one section of a fluidic conductor is introduced into an opening, a fluid sealing material is then introduced into the opening, and this opening is then entirely or partially closed by an intermediate substrate. Once the fluid sealing material has cured, the intermediate substrate, for example, can then be removed again. This is desirably when planar surfaces are intended to be produced along the base substrate of the fluidic structure, and are also not intended to be interrupted by the cured fluid sealing material.

If a corresponding layer structure comprising a plurality of substrates, for example a base substrate, an intermediate substrate and a cover substrate, is used, then various methods can be used in order to connect these substrates. The choice of a suitable method is in this case dependent, of course, on the corresponding characteristics, in particular the choice of materials for the substrates that are used. Adhesive methods can illustratively be used for connection of the substrates, or else welding methods, in particular laser welding methods or ultrasound welding methods. Laser or ultrasound welding methods may illustratively be used, for example, for the connection of appropriate plastic substrates. Alternatively or additionally, it is also possible to use thermal bonding methods.

In addition to the refinements of the proposed method, a corresponding fluidic structure is also proposed, in particular a fluidic structure one of whose refinements is produced using the described method. The fluidic structure has at least one base substrate with at least one externally accessible opening, at least one fluidic conductor which has at least one inner lumen and at least one conductor wall, with at least one section of the at least one fluidic conductor being arranged in the at least one opening, at least one curable sealing material, which is introduced into the at least one opening, in the cured state, with the curable sealing material entirely or partially filling at least one intermediate space between at least one wall of the at least one opening and at least one fluidic conductor, at least one fluid channel and at least one connecting channel between at least one inner lumen in the at least one fluidic conductor and at least one fluid channel, with the at least one connecting channel passing through at least one conductor wall. The configuration of the said elements may in this case illustratively be chosen on the basis of the refinements and embodiments mentioned above.

The described method makes it possible to produce a dead volume of a fluidic connection between one or more fluidic conductors and a substrate, for example the remaining part of a fluidic structure, to a greatly reduced extent and reproducibly. This is due in particular to the fact that the curable fluid sealing material can completely fill any opening which remains between the at least one fluidic conductor and the wall of the at least one opening, in which case material is removed and/or displaced as appropriate just at those points at which cavities and/or openings are required, in particular for the purpose of production of the at least one connecting channel.

Furthermore, the described method can be used to freely choose and define the location of the fluidic connection between one or more fluidic conductors and the other components of a fluidic structure. In particular, it is also possible to largely freely define the position of the at least one connecting channel. In addition, a plurality of fluid channels can also be connected at the same time to a single fluidic conductor, for example by producing a plurality of connecting channels which connect the inner lumen in the fluidic conductor to a plurality of conductor channels. This makes it possible, in particular, to produce distribution systems easily, which cannot be produced using the methods described above that are known from the prior art.

Furthermore, in the described method, the at least one fluidic conductor is not subject to any major mechanical load. This is desirable when thin-walled flexible tubes or tubes are used which are easily damaged during a corresponding assembly process with a number of the methods from the prior art that are mentioned above. In particular, there is no need for the at least one fluidic conductor, in particular a tube or flexible tube end, to strike against a stop.

Furthermore, the described method does not require any complex adjustment steps, as are essential in many methods from the prior art. For example, in particular, there is no need to introduce into a base substrate any axial holes to a conductor channel in a base substrate. It is particularly simple in this case if the corresponding section of the fluidic conductor can simply be inserted into a corresponding groove from above, and need not be pushed into an opening from the front.

Furthermore, the described method also has good reproducibility. The curable fluid sealing material can, in particular, completely fill the cavity between the fluidic conductor and the wall of the opening and, for example, can also close the fluidic conductor, in particular a tube end or flexible tube end, completely. The actual fluidic connection between one or more fluid channels in one or more of the substrates and the inner lumen in the fluidic conductor is then produced, in particular once the fluidic sealing material has cured. The fluidic connection, in particular the at least one fluidic connecting channel, is therefore not dependent on how far the fluid sealing material flows into the inner lumen in the fluidic conductor. Thus, in contrast to the methods known from the prior art, this method is in particular also suitable for large-scale usage, in particular for large-scale production of medical diagnostic appliances, analytical apparatuses or microreaction chambers.

Further details and features of the invention will become evident from the following description of preferred exemplary embodiments and in conjunction with the dependent claims. In this case, the respective features can be implemented in their own right or combined with one another in groups of two or more. The invention is not restricted to the exemplary embodiments.

### BRIEF DESCRIPTION OF THE DRAWINGS

The exemplary embodiments are illustrated schematically in the figures. Identical reference numbers in the individual figures in this case denote identical or functionally identical elements, or elements whose functions correspond to one another. In detail:

FIG. 1 shows a section illustration of a fluidic structure, from the side;

FIG. 2 shows a section illustration of an alternative fluidic structure to that shown in FIG. 1, viewed from above;

FIG. 3 shows an intermediate product during the production of a fluidic structure, with a base substrate and a fluidic conductor;

FIG. 4A shows a first embodiment of an opening which has been introduced into a base substrate, illustrated in the form of a section and viewed from the front;

FIG. 4B shows an alternative refinement to that shown in FIG. 4A, with a trapezoidal opening cross section;

FIG. 4C shows an alternative refinement to that shown in FIGS. 4A and 4B, with a U-shaped cross section;

FIG. 4D shows an alternative refinement of an opening to that shown in FIGS. 4A to 4C, in the form of a hole which has been introduced into a base substrate and has a rectangular cross section;

FIG. 5 shows one embodiment of an opening in the form of a cutout in a base substrate, in the form of a section illustration from the side;

FIG. 6 shows an intermediate product during the production of a fluidic structure according to the invention, having a base substrate, a fluidic conductor and an intermediate substrate in the form of a sheet;

FIG. 7 shows an alternative refinement of an intermediate product to that shown in FIG. 6, with a small plate instead of a sheet;

FIG. 8 shows a section illustration of an intermediate product of a fluidic structure having a supply channel for supplying a curable fluid sealing material, viewed from above;

FIG. 9 shows an intermediate product during the production of a fluidic structure with a base substrate, a fluidic conductor, an intermediate substrate and a fluid sealing material;

FIG. 10 shows an intermediate product, corresponding to that shown in FIG. 9, after removal of the intermediate substrate;

FIG. 11 shows an intermediate substrate during the production of a fluidic structure with a base substrate, a fluidic conductor, a cured sealing material, an intermediate substrate and a connecting channel which passes through the intermediate substrate, the sealing material and a conductor wall of the fluidic conductor; and

FIG. 12 shows a schematic flowchart of one embodiment of a method for production of a fluidic structure.

### DESCRIPTION OF THE ILLUSTRATIVE EMBODIMENTS

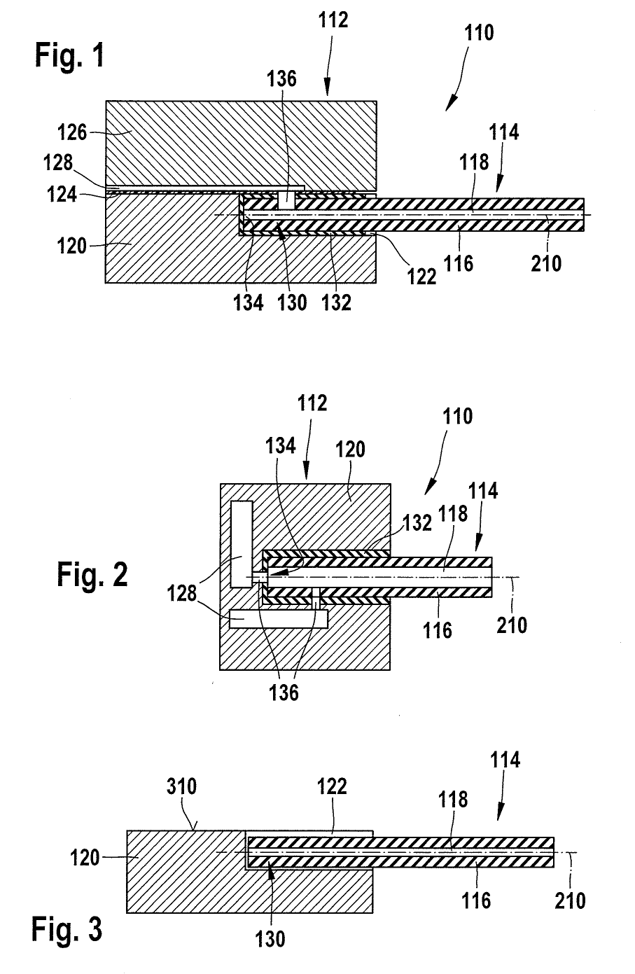

FIG. 1 shows a first exemplary embodiment of a fluidic structure 110, illustrated in the form of a section from the side.

The structure has a fluidic chip 112 which is produced in the form of layers, as well as a fluidic conductor 114 with a conductor wall 116 and an inner lumen 118. In this exemplary embodiment, the conductor wall 116 is composed of silicone. The expression conductor wall identifies the side boundary wall of the fluidic conductor 114 in FIG. 1.

The fluidic chip has a base substrate 120 into which an opening 122 is introduced. Furthermore, the structure has two further substrates, to be precise an intermediate substrate 124 and a cover substrate 126, which are applied to the base substrate in the stated sequence. While the intermediate substrate 124 is unstructured in this exemplary embodiment, the cover substrate 126 in this example has a fluid channel 128 which is immediately adjacent to the intermediate substrate 124 in such a way that the intermediate substrate 124 forms one wall of the fluid channel 128.

In this exemplary embodiment, a connection is produced between the fluidic conductor 114 in the form of a flexible tube and the fluidic chip 112 by inserting an open end 130 of the fluidic conductor 114 into the opening 122 in the base substrate 120. In this case, the open end 130 of the fluidic conductor 114 is surrounded by a sealing material 132. This sealing material 132 entirely or partially fills the volume of the opening 122 around the open end 130 of the fluidic conductor 114, in such a way that a conductor opening 134 is completely sealed by the sealing material 132. The sealing material 132 is immediately adjacent to the intermediate substrate 124. The open end 130 of the fluidic conductor 114 is also firmly connected by means of the sealing material 132 to the fluidic chip 112, in such a way that a considerable amount of force is required in order to remove the fluidic conductor 114 from the fluidic chip 112. The sealing material 132 thus results in the connection between the fluidic conductor 114 and the fluidic chip 112 being highly mechanically robust, as well as providing the stated sealing effect.

Furthermore, the fluidic structure 110 has a connecting channel 136 which, in this exemplary embodiment, has a cylindrical shape and connects the fluid channel 128 in the cover substrate 126 to the inner lumen 118 in the fluidic conductor 114. During this process, the connecting channel 136 passes through the unstructured intermediate substrate 124, the sealing material 132 and the conductor wall 116 of the fluidic conductor 114. The connecting channel 136 thus produces a connection, through which a fluid, for example a liquid or a gas can flow freely, between the inner lumen 118 in the fluidic conductor 114 and the fluidic chip 112, in particular the fluid channel 128.

In the illustrated embodiment, the fluidic structure 110 has only one fluid channel 128, which is arranged in the cover substrate 126. Alternatively or additionally, the fluidic structure 110 may also have further fluid channels 128 which, for example, can also or additionally be accommodated in the base substrate 120. If the fluid channels are accommodated only in the base substrate 120, then the entire fluidic connection between the fluidic conductor 114 and the fluidic chip 112 is provided in a single substrate (the base substrate 120). In addition to the illustrated embodiment, in which the fluid channel 128 is arranged on the boundary surface between two substrates, in this case on the boundary surface between the cover substrate 126 and the intermediate substrate 124, a refinement of fluid channels 128 is also possible in which these fluid channels 128 are arranged in the interior of a substrate 120, 124, 126, for example in the form of holes. In addition to the illustrated elongated shape of the fluid channels 128, it is also feasible for other fluidic cavities to be accommodated, for example microreaction chambers, in one or more of the substrates 120, 124 and 126.

FIG. 2 shows an alternative refinement of a fluidic structure 110 to that shown in FIG. 1, illustrated in the form of a section viewed from above, with the inner lumen 118 in the fluidic conductor 114 being connected to two fluid channels 128 via connecting channels 136 in this exemplary embodiment. In this exemplary embodiment, the connecting channels 128 are formed in the base substrate 120, for example in the form of trenches or grooves which, for example, are arranged on the boundary surface between the base substrate 120 and the intermediate substrate 124 (see FIG. 1). After being covered by the intermediate substrate 124, these grooves in the base substrate 120 thus form closed fluid channels 128. Two connecting channels 136 are provided in this exemplary embodiment, with one connecting channel 136 running parallel to one axis 210 of the fluidic conductor 114, and thus opening directly in the conductor opening 134 of the fluidic conductor 114. A second connecting channel 136 runs at right angles to the axis 210 of the fluidic conductor, and in the process passes through the sealing material 132 and the side conductor wall 116 of the fluidic conductor 114. The inner lumen 118 in the fluidic conductor 114 is in this way connected to a plurality of fluid channels 128. In this exemplary embodiment, by way of example, the connecting channels 136 can be produced by milling or laser ablation, while, in contrast, the connecting channel 136 in the exemplary embodiment shown in FIG. 1 is illustratively produced by mechanical drilling or laser beam drilling.

One production method for a fluidic structure 110, for example based on the embodiment versions illustrated in FIGS. 1 and 2, will be described in the following text with reference to FIGS. 3 to 11, which each illustrate intermediate products, and with reference to the schematic flowchart shown in FIG. 12. In this case it should be noted that the method illustrated in FIG. 12, in particular, need not necessarily be carried out in the stated sequence and that additional method steps, which are not illustrated in FIG. 12, may also be carried out.

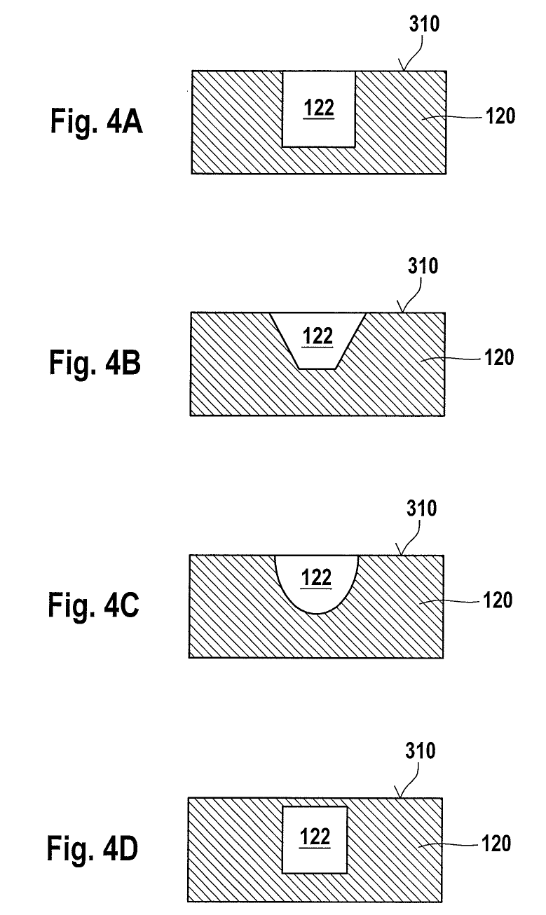

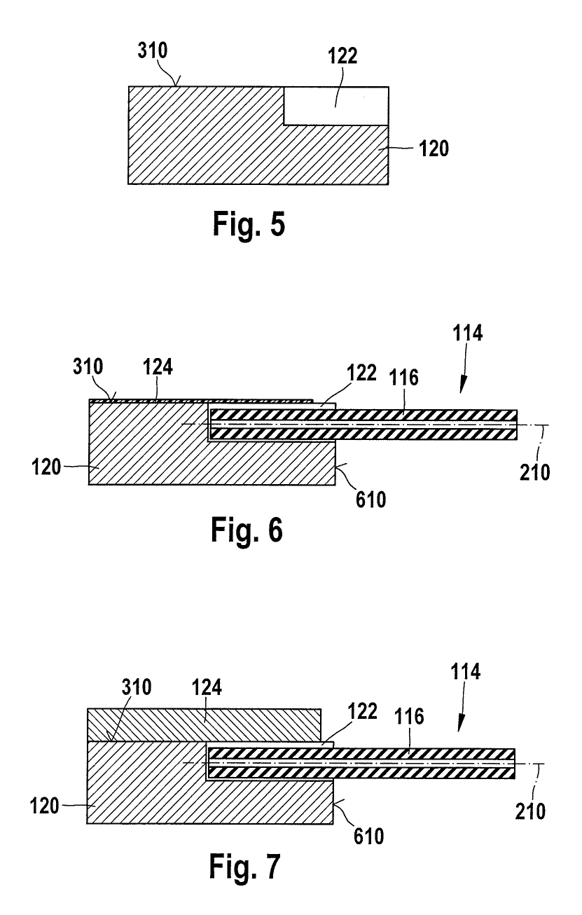

First of all, an opening 122 is introduced into a base substrate 120 in a first method step (method step 1210 in FIG. 12). This opening 122 may be formed in various ways. Different embodiments of this opening 122 are illustrated in FIGS. 4A to 4D, and in FIG. 5. In particular, the opening 122 may have a groove which is introduced into a surface 310 of the base substrate 120, as is illustrated in FIGS. 4A to 4C. This groove may, in particular, have a rectangular cross section (FIG. 4A), a trapezoidal cross section (FIG. 4B), or else a U-shaped cross section (FIG. 4C). In the case of the trapezoidal cross section shown in FIG. 4B, it is desirable for the longer of the two parallel sides of the trapezoid to rest on the surface 310 of the base substrate 120. Alternatively or additionally, the opening 122 may also have a hole as is illustrated by way of example in FIG. 4D. This hole may, for example, be a blind hole. The hole may, in particular, have a rectangular or round cross section. On the basis of the exemplary embodiment illustrated in FIG. 5, the opening 122 may also be in the form of a simple cutout on the surface 310 of the base substrate 120. Further refinements, for example with an alternative cross section (for example a V-shaped cross section) of the groove or of the opening 122 are feasible.

A section 130 of a fluidic conductor 114 is then inserted (method step 1212 in FIG. 12) into the opening 122 in the base substrate 120, as illustrated in FIG. 3. In this case, the inserted section 130 is the open end of a fluidic conductor 114 in the form of a flexible tube. In the case of an opening 122 in the form of a hole and based on the exemplary embodiment illustrated in FIG. 4D, the expression “insertion” should correspondingly be understood as meaning that the open end 130 of the fluidic conductor 114 is pushed into the opening 122. However, since the external dimensions of the fluidic conductor 114 are smaller than the dimensions of the hole 122, no force need be applied in this exemplary embodiment in order to push the open end 130 into the opening 122, in contrast to the prior art, so that, in particular, this also reduces the risk of damage to the fluidic conductor 114.

The surface 310 of the base substrate 120, as is illustrated in FIGS. 6 and 7, is then covered by an unstructured intermediate substrate 124, with the opening 122 being at least partially closed along the surface 310 in the exemplary embodiment illustrated in FIGS. 6 and 7, in which the opening 122 is in the form of a groove, whose long side is open towards the surface 310 and whose narrow side is open towards the end surface 610 of the base substrate 120. In the exemplary embodiment illustrated in FIG. 6, the intermediate substrate 124 is a thin sheet, for example a plastic sheet (for example a plastic sheet whose material is polycarbonate), while in the exemplary embodiment shown in FIG. 7 it is a small plate which can be connected to the base substrate 120 (for example, likewise a plastic sheet whose material is polycarbonate).

A curable fluid sealing material 132 is then (method step 1214 in FIG. 12) introduced into the opening 122 in such a way that the sealing material 132 fills the remaining cavity between the conductor wall 116 of the fluidic conductor 114 and the wall of the cavity 122, forming a seal. During this process, the sealing material 132 can also partially enter the conductor opening 134 in the fluidic conductor 114. As is illustrated in FIG. 9, the unstructured intermediate substrate 124 in this case limits the filling height of the sealing material 132, so that the sealing material 132 ends flush with the surface 310 of the base substrate 120. In the exemplary embodiments illustrated in FIGS. 6, 7 and 9, the intermediate substrate 124 ends in front of the end surface 610 of the base substrate 120, but this is not absolutely essential, so that it is also possible to use intermediate substrates 124 which project beyond the end surface 610, or intermediate substrates 124 which end flush with the end surface 610 of the base substrate 120.

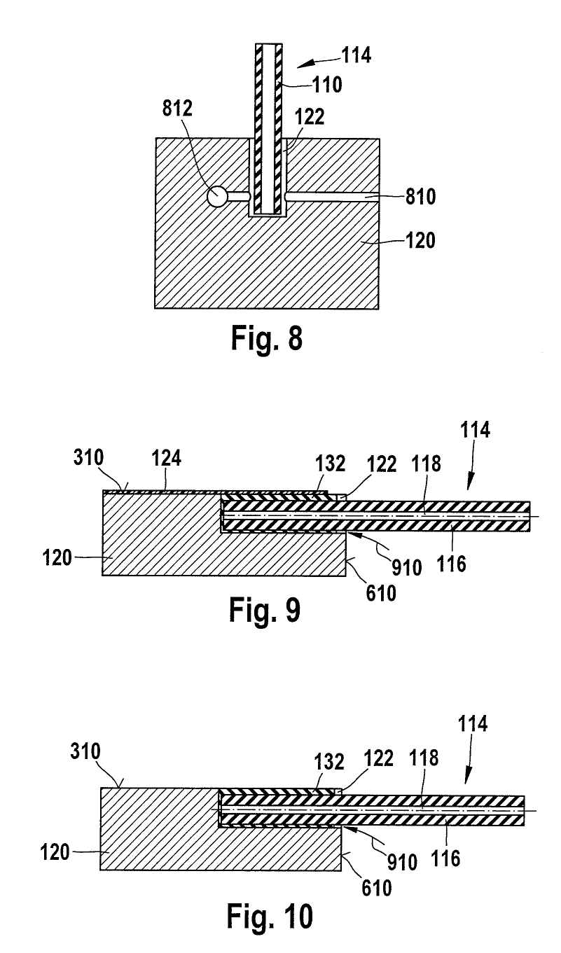

The fluidic curable sealing material 132 is inserted into the opening 122 in the base substrate 120 from the end surface 610, for example, as can be seen from FIGS. 9 and 10 (filling direction 910). Alternatively, as is illustrated in the form of a section illustration in the exemplary embodiment shown in FIG. 8, it is also possible to use filling channels 810. In the exemplary embodiment illustrated in FIG. 8, these filling channels 810 are in the form of trenches along the surface 210 of the base substrate 120, with these trenches running at right angles to the opening 122. Furthermore, the filling channels 810 have a widened supply opening 812 into which the curable fluid sealing material 132 can be inserted, in order then to flow along the filling channels 810 into the opening 122. This also ensures that volume changes of the curable fluid sealing material 132 can be compensated for, for example by sealing material 132 escaping into the filling channels 810 while curing. This avoids stresses during curing. In this exemplary embodiment, by way of example, a light-curing adhesive, such as Wellomer UV4032, can be used as the curable fluid sealing material 132 and which can be cured in particular by the use of UV light.

The curable fluid sealing material 132 is then (method step 1216 in FIG. 12) appropriately cured, so that the open end 130 of the fluidic conductor 114 is firmly mounted in the opening 122, and the conductor opening 132 is closed such that it is sealed. During the curing process, sealing material 132 can additionally enter the conductor opening 134 in the open end 130 of the fluidic conductor 114 to a minor extent, thus additionally increasing the sealing effect and the mechanical robustness of the connection.

As described above, the sealing material 132 may be cured partially or completely. Furthermore, various techniques may be used for curing, as likewise described above, in particular curing under the influence of light, for example under the influence of UV light. This use of light may take place, for example, through the intermediate substrate 124 or else through the base substrate 120, with the intermediate substrate 124 and/or the base substrate 120 illustratively being transparent at the light wavelength that is used, in this case. A locally restricted light influence, for example in the form of a laser beam or by means of a shadow mask, may also be used.

Once the sealing material 132 in the opening 122 has been cured, the intermediate substrate 124 may optionally remain on the base substrate 120, particularly when the intermediate substrate 124 is in the form of a thin sheet, or alternatively may be removed from the base substrate 120. In the case of the layer configuration of the fluidic structure 110 as illustrated in FIG. 1, the intermediate substrate 124 has not been removed, and thus forms a permanent component of the layer structure of the fluidic chip 112.

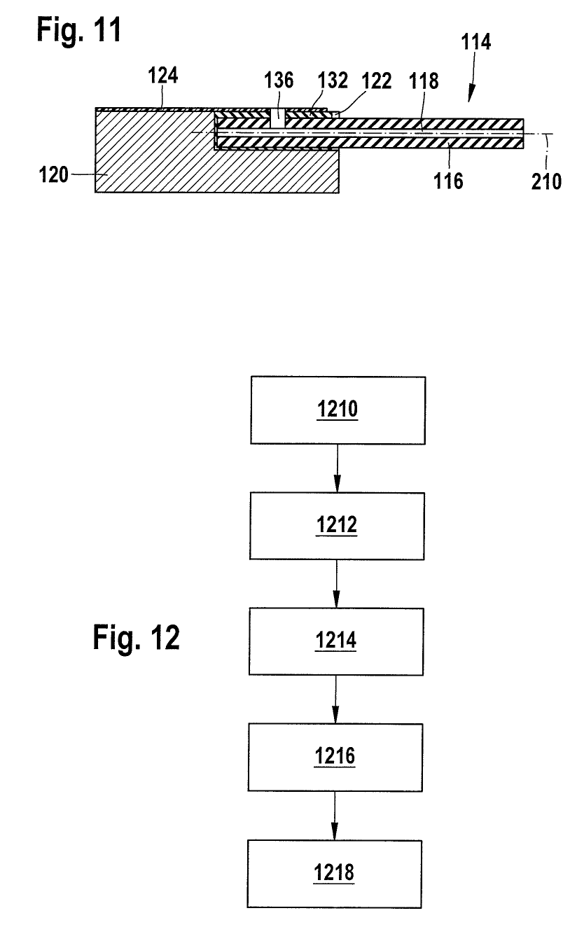

A connecting channel 136 is then exposed (see method step 1218 in FIG. 12) to the inner lumen 118 in the fluidic conductor 114, as is illustrated by way of example in FIG. 11. In this exemplary embodiment, the connecting channel 136 extends at right angles to the axis 210 of the fluidic conductor 114 through the intermediate substrate 124, the sealing material 132 (which has now been cured) and the conductor wall 116 of the fluidic conductor 114. By way of example, this opening may be produced by means of a mechanical drill or preferably by means of a laser, in particular a CO₂ laser or excimer laser. As described above however, other methods may also be used in this case, such as wet-chemical etching methods, lithographic methods or dry etching.

In a final step, the intermediate product illustrated in FIG. 11 is then added to the fluidic structure 110 illustrated in FIG. 1 by applying a cover substrate 126 to the intermediate substrate 128. As illustrated at the top of FIG. 1, this cover substrate 126 has a fluid channel 128 which, for example, has been introduced into the cover substrate 126 by milling, etching, laser ablation or other methods. The fluid channel 128 is in this case arranged, and the cover substrate 126 is aligned with respect to the base substrate 120, in such a way that the fluid channel 128 is located above the connecting channel 136 to the inner lumen 118 in the fluidic conductor 114. This results in a connection through which a fluid can flow being produced between the fluid channel 128 and the inner lumen 118 in the fluidic conductor via the connecting channel 136. As described above, the substrates 126, 124 and 120 can be connected to one another by various suitable joining techniques. In particular, the substrates can be welded by means of a suitable laser, or else can be adhesively bonded. Alternatively, a suitable clamping technique is also feasible, which presses the individual substrates 120, 124, 126 against one another and is detachable again, if required.

List of reference symbols

| | |
|---|---|
| 110 | Fluidic structure |
| 112 | Fluidic chip |
| 114 | Fluidic conductor |
| 116 | Conductor wall |
| 118 | Inner lumen |
| 120 | Base substrate |
| 122 | Opening |
| 124 | Intermediate substrate |
| 126 | Cover substrate |
| 128 | Fluid channel |
| 130 | Open end of the fluidic conductor 114 |
| 132 | Sealing material |
| 134 | Conductor opening |
| 136 | Connecting channel |
| 210 | Axis of the fluidic conductor 114 |
| 310 | Surface of the base substrate 120 |
| 610 | End surface of the base substrate 120 |
| 810 | Filling channels |
| 812 | Supply opening |
| 910 | Filling direction |
| 1210 | Introduction of an opening 122 into a base substrate 120 |
| 1212 | Introduction of a section 130 of a fluidic conductor 114 into the |
| | opening 122 |
| 1214 | Introduction of a fluid sealing material 132 into the opening 122 |
| 1216 | Curing of the sealing material 132 |
| 1218 | Production of a connecting channel 136 |

1-35. (canceled)

36. A method for production of a fluidic structure, the method comprising the following steps performed in the given order:
a) introducing at least one externally accessible opening into at least one base substrate of the fluidic structure,
b) partially introducing at least one section of a fluidic conductor, which has at least one inner lumen and at least one conductor wall, in particular of a tube or flexible tube, into the at least one opening,
c) introducing at least one curable fluid sealing material into the at least one opening,
d) entirely or partially curing the at least one fluid sealing material, and
e) producing at least one connecting channel between at least one inner lumen in the at least one fluidic conductor and at least one fluid channel in the fluidic structure, the at least one connecting channel passing through at least one conductor wall.

37. The method of claim 36, further comprising:
f) applying at least one intermediate substrate and/or cover substrate to the at least one base substrate, with the at least one cover substrate and/or the at least one intermediate substrate partially closing the at least one opening.

38. The method of claim 37, wherein at least one cover substrate is applied, with the at least one cover substrate having at least one fluid channel.

39. The method of claim 37, wherein at least one intermediate substrate is applied, with the intermediate substrate being removed again after carrying out method step d).

40. The method of claim 36, wherein step a) is carried out such that the at least one opening has at least one groove with a rectangular, round, U-shaped or V-shaped cross section.

41. The method of claim 36, wherein the at least one opening is in the form of a groove with a cross section in the form of a trapezoid.

42. The method of claim 41, wherein the longer edge of the trapezoid rests on one surface of the at least one base substrate.

43. The method of claim 36, wherein the at least one opening has at least one hole with a round, oval or polygonal cross section.

44. The method of claim 36, wherein the at least one section of the at least one fluidic conductor which is introduced in step b) has at least one open end of the at least one fluidic conductor.

45. The method of claim 44, wherein, in step c), the at least one conductor opening in the open end is closed by the at least one curable fluid sealing material.

46. The method of claim 36, wherein, in step c), the at least one curable fluid sealing material is introduced into the at least one opening through at least one filling channel, which is connected to at least one opening, in the fluidic structure.

47. The method of claim 46, wherein the at least one filling channel passes through at least one base substrate and/or at least one intermediate substrate.

48. The method of claim 36, wherein, in step d), electromagnetic rays, in particular light, are used to influence at least one curable fluid sealing material.

49. The method of claim 48, wherein the electromagnetic rays pass entirely or partially through the fluidic structure before influencing the at least one curable fluid sealing material.

50. The method of claim 36, wherein, in step d), the at least one curable fluid sealing material is influenced thermally, in particular in the form of a temperature increase or a temperature decrease.

51. The method of claim 36, wherein, in step d), polymerization, in particular photopolymerization, and/or a liquid-to-solid phase transition, in particular solidification, of the at least one curable fluid sealing material takes place.

52. The method of claim 36, wherein step c) is carried out entirely or partially at an increased pressure, with at least one viscoelastic or pseudoplastic sealing material being used,
and wherein, in step d), the pressure is reduced below that for step c), by which the at least one viscoelastic or pseudoplastic sealing material is entirely or partially cured.

53. The method of claim 36, wherein, in step c), the curable fluid sealing material has at least one self-curing cement.

54. The method of claim 36, wherein, in step c), at least one cavity which remains after carrying out step b) in the at least one opening is completely filled with the at least one curable fluid sealing material.

55. The method of claim 36, wherein, in step e), at least one connecting channel is produced between at least one inner lumen in the at least one fluidic conductor and at least one fluid channel which is introduced entirely or partially into the at least one base substrate and/or at least one fluid channel which is introduced entirely or partially into the at least one cover substrate.

56. The method of claim 36, wherein a mechanical drilling method and/or milling method and/or a stamping method and/or laser beam drilling and/or a wet-chemical or dry etching method is used in step e).

57. The method of claim 36, wherein the connecting channel which is produced in step e) passes through at least one intermediate substrate and/or at least one sealing material in addition to the at least one conductor wall.

58. The method of claim 36, wherein, in addition to the at least one base substrate, at least one further substrate, in particular a cover substrate and/or an intermediate substrate, is used, with at least two of the substrates being connected by an adhesion method and/or a welding method, in particular a laser welding method or ultrasound welding method, and/or a thermal bonding method.

59. A fluidic structure comprising:
at least one base substrate, with the at least one base substrate having at least one externally accessible opening,
at least one fluidic conductor which has at least one inner lumen and at least one conductor wall, with at least one section of the at least one fluidic conductor being arranged in the at least one opening, and wherein the at least one section of the at least one fluidic conductor has at least one open end of the at least one fluidic conductor,
at least one curable sealing material, which is introduced into the at least one opening in the cured state, with the curable sealing material entirely or partially filling at least one intermediate space between at least one wall of the at least one opening and at least one fluidic conductor,
at least one fluid channel, and
at least one connecting channel between at least one inner lumen in the at least one fluidic conductor and at least one fluid channel, with the at least one connecting channel passing through at least one conductor wall of the at least one fluidic conductor.

60. The fluidic structure of claim 59, wherein the at least one connecting channel passes entirely or partially through the at least one curable sealing material in the cured state.

61. The fluidic structure of claim 59, wherein the fluidic structure further has at least one cover substrate, with the at least one cover substrate partially closing the at least one opening.

62. The fluidic structure of claim 61, wherein the cover substrate has at least one fluid channel.

63. The fluidic structure of claim 62, wherein the at least one fluid channel of the at least one cover substrate has at least one groove.

64. The fluidic structure of claim 61, wherein at least one intermediate substrate is introduced between the at least one base substrate and the at least one cover substrate.

65. The fluidic structure of claim 64, wherein the at least one connecting channel passes through the at least one intermediate substrate.

66. The fluidic structure of claim 59, wherein the at least one opening has at least one groove with a rectangular, round, U-shaped, V-shaped or trapezoidal cross section.

67. The fluidic structure of claim 59, wherein the at least one opening has at least one hole with a round, oval or polygonal cross section.

68. The fluidic structure of claim 59, wherein the at least one open end is closed by the at least one curable sealing material in the cured state.

69. The fluidic structure of claim 59, wherein the at least one section of the at least one fluidic conductor is firmly connected to the at least one base substrate by means of the at least one curable sealing material in the cured state.
